(19) United States
(12) Patent Application Publication
(10) Pub. No.: US 2026/0162539 A1
(43) Pub. Date: Jun. 11, 2026

(54) SAFETY NAVIGATION SUPPORT SYSTEM FOR A SHIP

(71) Applicant: Yong Koo SHIN, Changwon-si (KR)

(72) Inventor: Yong Koo SHIN, Changwon-si (KR)

(21) Appl. No.: 19/002,604

(22) Filed: Dec. 26, 2024

(30) Foreign Application Priority Data
Dec. 9, 2024 (KR) 10-2024-0181305

(51) Int. Cl. G08G 3/02; B63B 43/18; B63B 49/00; G06F 40/58

(52) U.S. Cl. CPC G08G 3/02; B63B 43/18; B63B 49/00; G06F 40/58; B63B 2201/02

(57) ABSTRACT

Disclosed herein is a safety navigation support system for a ship that can prevent marine accidents in advance by enabling the own ship to quickly recognize the other ship that called the own ship in a situation where the own ship is unaware of the risk of collision with other ships or a maritime hazard around the own ship. In accordance with the present invention, the safety navigation support system for a ship comprises a speech-to-text-conversion-unit that converts voice information received from other ships through the marine-radio-communication-device of the own ship into text information and stores the voice information and text information together for each ship; a ship-call-judgment-unit that analyzes each of the text information stored in the speech-to-text-conversion-unit to determine whether there is text information that matches the name or call sign of the own ship; a call-ship-designation-unit that designates the other ship that called the own ship from the text information of other ships stored in the speech-to-text-conversion-unit when the text information matching the name or call sign of the own ship is received through the ship-call-judgment-unit; and a call-ship-identification-display-unit that displays an image of the other ship specified on the screen of EDICS or RADAR differently from other ships when the call-ship-designation-unit designates the other ship that called the own ship.

### REFERENCE TO RELATED APPLICATIONS

This application claims the priority benefit of Korean Patent Application No. 10-2024-0181305 filed on Dec. 9, 2024, the entire contents of which are incorporated herein by reference.

### FIELD OF THE INVENTION

The present invention relates to a safe navigation support system for a ship, which can prevent marine accidents in advance by enabling the own ship to quickly recognize the other ship that called the own ship in a situation where the own ship is unaware of the risk of collision with other ships or a maritime hazard around the own ship.

### BACKGROUND OF THE INVENTION

In general, ships are equipped with the Automatic Identification System (AIS) adopted by the International Maritime Organization (IMO) to prevent marine accidents. The AIS is a device that automatically transmits and receives information such as the ship's location and identification information using radio waves.

In other words, AIS enables real-time identification of the location and movement path of all ships operating in the world's oceans through wireless communication technology, thereby helping nearby ships respond quickly in the event of an accident or emergency involving a ship at sea. It is also used for various purposes, such as navigation systems, route marking facility management, and search and rescue activities.

Both foreign ships passing through the coastal waters of the Republic of Korea and ships entering and leaving domestic ports are required to be equipped with AIS, and in particular, AIS installation has been made mandatory for fishing ships starting in January 2023. Although there are differences between countries, as well as domestically, the standards for AIS installation are gradually being strengthened worldwide, and even for small ships or leisure boats where AIS installation is difficult, at least V-PASS or FLOTTER are installed as an alternative to AIS function.

The AIS transmits various identification information such as position, speed, course, name, call sign, IMO number, etc. for a ship through the very high frequency band (for example VHF Ch 16). Therefore, ships, including the Vessel Traffic Service (VTS), can easily identify each other's position as well as detailed navigation information.

In addition, AIS has a plotting function based on the Global Positioning System (GPS) and a navigation function linked to the Electronic Chart Display Information System (ECDIS), and it can sound a proximity alarm to prevent collisions with other vessels in the vicinity or provide guidance services to distant destinations. It also provides useful judgment data by providing additional notification functions such as weather information, fuel level warnings, and grounding avoidance warnings.

Moreover, AIS operates in four major modes: the first is AIS mode, which displays general ship-related information; the second is search mode, which shows a list of ships visible on the surrounding radar screen, and allows detailed ship information to be viewed by clicking on each; the third is voice communication mode, and the fourth is MOB (Mobile Off Line) mode, which is mainly used for sending emails in situations where Internet connection is not possible, and can transmit or receive specific point coordinates to a server computer.

As conventional technologies applying the above-described AIS technology, there are Korean Patent No. 10-1800453 entitled ‘Ship collision avoidance system and method using AIS information’, Korean Patent No. 10-2596943 entitled ‘Collision risk area display device based on AIS navigation data and ship collision avoidance system using the same’, and in the case of Korean Patent No. 10-2543394 entitled ‘Automatic safe navigation support system for ships’, there is a technology that aims to prevent collision accidents in advance by identifying maritime hazards in advance and notifying surrounding ships of the risk of collision by transmitting voice synthesis messages without human intervention.

This does not deny the effectiveness of the prior art itself, such as marking of collision-risk vessels or areas for collision prevention based on AIS as mentioned above, or sending out voice synthesis messages in case of collision risk. However, first, it is not particularly useful in cases where the own ship first recognizes the risk of collision between other ships and avoids it, and second, in coastal areas or ports within the VTS area, many other ships are stationed close to the own ship, making it difficult to clearly define the risk of collision between the own ship and other ships.

Rather, the biggest problem is that when a call is made to the own ship via a marine-radio-communication-device from the other ship, it is difficult for the own ship to quickly recognize where the call is coming from because there are many other ships stationed around the ship.

That is, all ships moves to the international common channel 16 (VHF Ch 16) or the channel surrounding each VTS to communicate and perform traffic control. In this case, if there are many other ships stationed around your own ship, you need to listen to voice signals of other ships calling through a marine-radio-communication-device, click or touch the other ships displayed on EDICS or RADAR, and then check the name and call sign of the other ship that called the own ship. However, if there are many other ships stationed around your own ship, there is a problem that it takes a long time to check other ships that did not call you and designate the other ship that finally called the own ship.

Also, if neither the own ship nor the other ship is a domestic ship, but at least one of them is a foreign ship, the international common language, maritime English, can be used, but if they use different languages, it is difficult to recognize the call from the other ship. Furthermore, even if it is recognized, there is the problem that communication is difficult because the languages are different. For example, in the national maritime areas of each country, it is okay to communicate in the native language of each country as well as maritime English.

### SUMMARY OF THE INVENTION

The purpose of the present invention, invented to solve the above problems, is to provide a safety navigation support system for a ship, which can prevent marine accidents in advance by enabling the own ship to quickly recognize the other ship that called the own ship in a situation where the own ship is unaware of the risk of collision with other ships or a maritime hazard around the own ship, and can facilitate marine radio communication between the own ship and the other ship even when they use different languages.

The objects of the present invention are not limited to the above-mentioned objects and other objects that have not been mentioned above will become evident to those skilled in the art from the following description.

In accordance with the present invention, the above and other objects can be accomplished by the provision of a safety navigation support system for a ship, comprising EDICS and RADAR that display navigation information on each screen in conjunction with GPS and AIS along with various sensors installed on the ship, and a marine-radio-communication-device that transmits and receives voice signals between the own ship and other ships, and further comprising: a speech-to-text-conversion-unit that converts voice information received from other ships through a marine-radio-communication-device of the own ship into text information and stores the voice information and text information together for each ship; a ship-call-judgment-unit that analyzes each of the text information stored in the speech-to-text-conversion-unit to determine whether there is text information that matches the name or call sign of the own ship; a call-ship-designation-unit that designates the other ship that called the own ship from the text information of other ships stored in the speech-to-text-conversion-unit when the text information matching the name or call sign of the own ship is received through the ship-call-judgment-unit; and a call-ship-identification-display-unit that displays an image of the other ship specified on the screen of EDICS or RADAR differently from other ships when the call-ship-designation-unit designates the other ship that called the own ship.

In addition, the call-ship-identification-display-unit displays the name and call sign of the other ship as a text image next on the screen to the image of the other ship that called the own ship.

In addition, the call-ship-identification-display-unit displays a speaker-shaped icon on top of the image of the other ship that called the own ship.

In addition, the call-ship-identification-display-unit reproduces the voice information stored in the speech-to-text-conversion-unit through the marine-radio-communication-device of the own ship when the speaker-shaped icon is clicked or touched.

In addition, the safety navigation support system for a ship according to the present invention is characterized by further comprising a text-translation-storage-unit that translates the text information into the native language of the own ship and maritime English and saves it as text translation information when the text information stored in the speech-to-text-conversion-unit is not in the native language of the own ship or maritime English.

In addition, the call-ship-identification-display-unit displays not only the text image of the name and call sign of the other ship next to the image of the other ship that called the own ship, but also a text image of the text translation information stored in the text-translation-storage-unit.

In addition, the safety navigation support system for a ship according to the present invention is characterized by further comprising a voice-synthesis-storage-unit that converts the text translation information stored in the text-translation-storage-unit into voice translation information by synthesizing voice and saves it.

In addition, the call-ship-identification-display-unit outputs the voice translation information stored in the voice-synthesis-storage-unit through the marine-radio-communication-device of the own ship when the text image of the text translation information is clicked or touched.

A safety navigation support system for a ship according to the present invention has the following effects. The present invention can prevent marine accidents in advance by enabling the own ship to quickly recognize the other ship that called the own ship in a situation where the own ship is unaware of the risk of collision with other ships or a maritime hazard around the own ship, and can facilitate marine radio communication between the own ship and the other ship even when they use different languages.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a configuration diagram illustrating one embodiment of a safety navigation support system for a ship in accordance with the present invention;

FIG. 2 is a configuration diagram illustrating the operation process of the speech-to-text-conversion-unit in the embodiment of FIG. 1;

FIG. 3 is a configuration diagram illustrating the operation process of the ship-call-judgment-unit of the embodiment of FIG. 1 based on the embodiment of FIG. 2;

FIG. 4 is a configuration diagram illustrating the operation process of the call-ship-identification-display-unit in the embodiment of FIG. 1 based on the embodiment of FIG. 3;

FIG. 5 is a configuration diagram illustrating other operation process of the call-ship-identification-display-unit in the embodiment of FIG. 4;

FIG. 6 is a configuration diagram illustrating another operation process of the call-ship-identification-display-unit in the embodiment of FIG. 4;

FIG. 7 is an enlarged view of the ‘A’ portion displayed on the screen of EDICS in the embodiment of FIG. 6, and is a configuration diagram illustrating the operation process of the speech-to-text-conversion-unit and the marine-radio-communication-device when the speaker-shaped icon is clicked or touched;

FIG. 8 is a configuration diagram illustrating other embodiment of a safety navigation support system for a ship in accordance with the present invention;

FIG. 9 is a configuration diagram illustrating the operation process of the speech-to-text-conversion-unit and the text-translation-storage-unit in the embodiment of FIG. 8;

FIG. 10 is a configuration diagram illustrating the operation process of the call-ship-identification-display-unit in the embodiment of FIG. 8 based on the embodiment of FIG. 9;

FIG. 11 is a configuration diagram illustrating the operation process of the text-translation-storage-unit and the voice-synthesis-storage-unit in the embodiment of FIG. 8 based on the embodiment of FIG. 9; and

FIG. 12 is an enlarged view of the ‘B’ portion displayed on the screen of EDCIS in the embodiment of FIG. 10 based on the embodiment of FIG. 11, and is a configuration diagram illustrating the operation process of the voice-synthesis-storage-unit and the marine-radio-communication-device when the text image of the text translation information is clicked or touched.

### DETAILED DESCRIPTION OF THE INVENTION

Hereinafter, with reference to the accompanying drawings, preferred embodiments of an apparatus for testing liquefied hydrogen valve in accordance with the present invention will be described in detail.

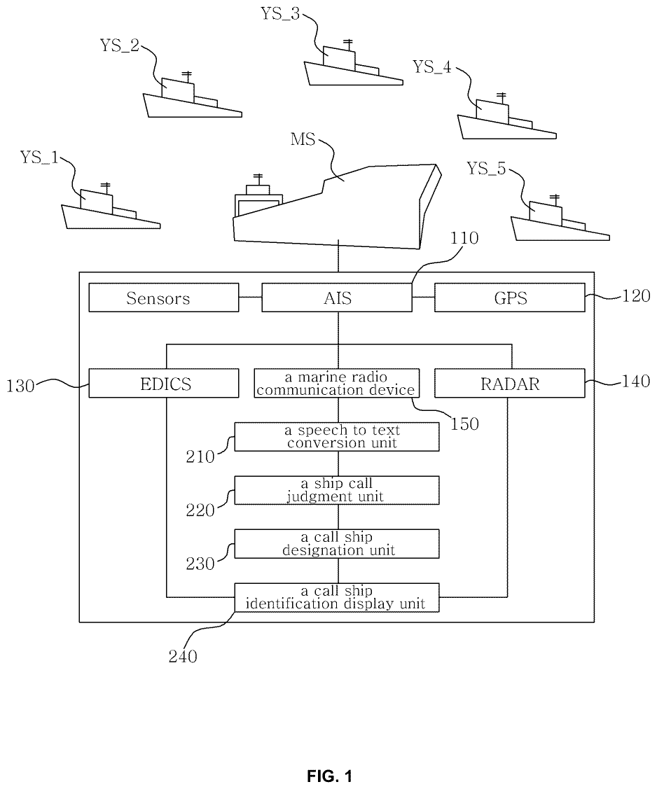

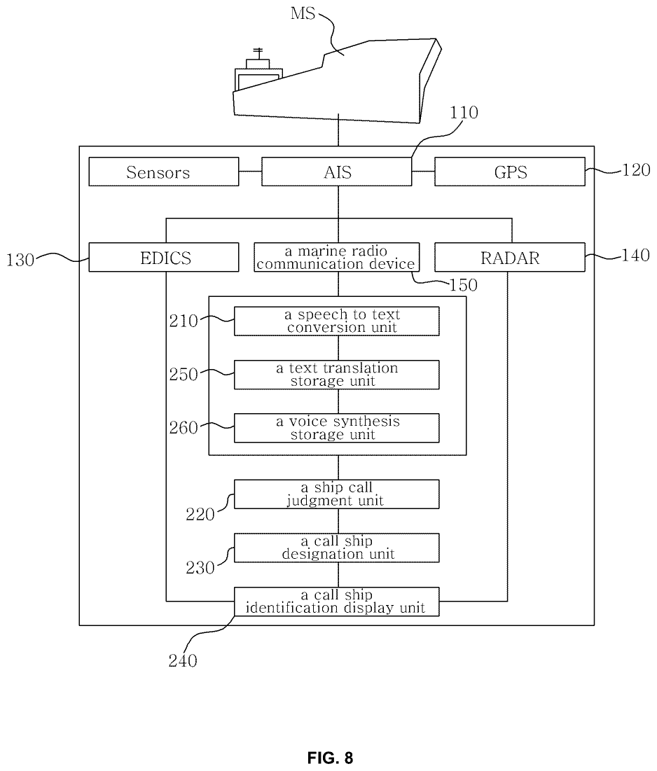

A safety navigation support system for a ship in accordance with the present invention, as shown in FIG. 1, includes EDICS 130 and RADAR 140 that display navigation information on each screen in conjunction with GPS 120 and AIS 110 along with various sensors installed on the ship, and a marine-radio-communication-device 150 that transmits and receives voice signals between the own ship (MS) and other ships (YS). In particular, the present invention includes a speech-to-text-conversion-unit 210, a ship-call-judgment-unit 220, a call-ship-designation-unit 230, and a call-ship-identification-display-unit 240 as shown in FIGS. 1 to 7, and may further includes a text-translation-storage-unit 250 and a voice-synthesis-storage-unit 260 as shown in FIGS. 8 to 12.

There are various sensors installed for ship navigation, such as magnetic compass, gyro compass, echo sounder, speed & distance measuring device, rate of turn indicator, and rudder indicator.

In addition, AIS 110 is an Automatic Identification System that automatically displays navigation information such as the ship's name, course, speed, and location, and GPS 120 is a Global Positioning System that allows you to accurately determine your location anywhere in the world using artificial satellites.

In addition, EDICS 130 is an Electronic Chart Display & Information System that displays chart information and surrounding information through a computer, and RADAR 140 is a Radio Detecting and Ranging device that detects objects using the characteristics of radio waves and determines their direction and distance.

A marine-radio-communication-device 150 is used on the sea, not on land, and uses VHF (Very High Frequency) electromagnetic waves in the 100 MHz band (especially 156 to 174 MHz). For example, the international common channel used by all ships is channel 16 (VHF Ch 16, 156.8 MHz), and each country or region's VTS (Vessel Traffic Service) calls each ship through the international common channel and communicates and controls the ship by moving to the channel surrounding each VTS.

The above-described various sensors, AIS 110, GPS 120, EDICS 130, RADAR 140 and the marine-radio-communication-device 150 are components that are essential for the navigation of a ship, and conventional technologies that add various functions to enable more convenient and safe navigation by utilizing each of these devices are widely known. Under this background, the present invention aims to support the own ship (MS) to quickly recognize the other ship_3 (YS_3) that called the own ship (MS) when a danger at sea or a danger of collision with a nearby other ships (YS) occurs in a situation where the own ship (MS) is not aware of it.

For example, when other ship (YS_n) calls to the own ship (MS), it states the name and call sign of the own ship (MS), then states its name and call sign, and then makes a request to avoid collision. At this time, the own ship (MS) must hear call and confirm where other ship (YS_n) is and what its name and call sign are. To this end, the own ship (MS) must check the navigation information of other ships (YS) by looking at the screen of EDCIS 140 and RARAR 150 and clicking or touching the image of other ships (YS) displayed on the screen respectively. In this case, as shown in FIG. 1, when there are a large number of other ships (YS_1˜5) around the own ship (MS), it is difficult to recognize the other ship_3 (YS_3) that called the own ship (MS) at once. Since each image of other ships (YS_1˜5) displayed on the screen must be checked by clicking or touching, it inevitably takes time for the own ship (MS) to recognize the other ship_3 (YS_3) that called the own ship (MS).

Therefore, the present invention comprises a speech-to-text-conversion-unit 210, a ship-call-judgment-unit 220, a call-ship-designation-unit 230, and a call-ship-identification-display-unit 240 as shown in FIG. 1, so that the own ship (MS) can quickly recognize the other ship_3 (YS_3) that called the own ship (MS) when a danger at sea or a risk of collision with surrounding other ships (YS_1˜5) occurs in a situation in which the own ship (MS) is unaware.

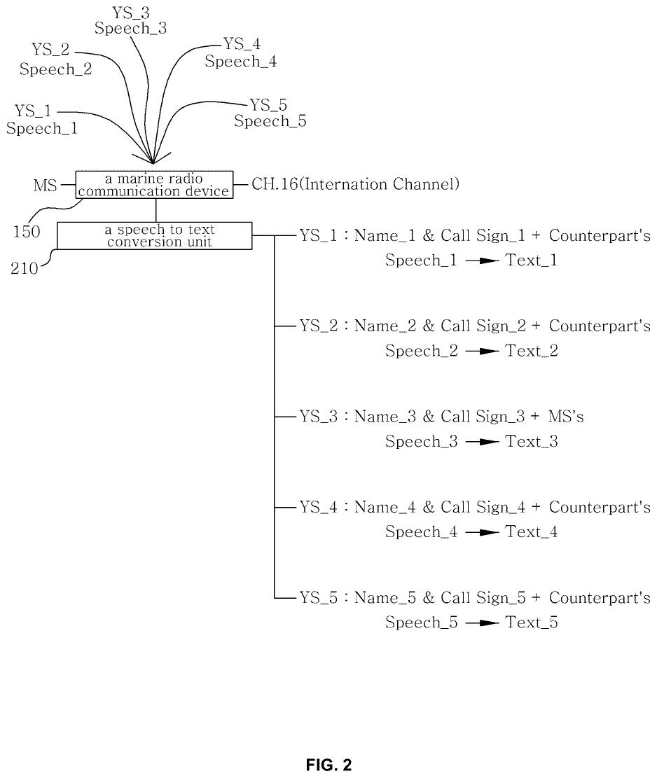

A speech-to-text-conversion-unit 210, as shown in FIG. 2, converts voice information (Speech_1˜5) received from other ships (YS_1˜5) through the marine-radio-communication-device 150 of the own ship (MS) into text information (Text_1˜5) and stores the voice information (Speech_1˜5) and text information (Text_1˜5) together for each ship. That is, the speech-to-text-conversion-unit 210 is a voice recognition technology, which is an STT (Speech to Text) technology, and is a technology that receives voice information (Speech) and obtains text information (Text), which is a corresponding phrase. Currently, there are WaveNet, etc. as an STT model using deep learning, and there are Google Web, Google Cloud, Bing, Houndify, IBM, Wit, Sphinx, etc. as speech recognition AI technologies that are pre-trained and distributed for free.

For example, as shown in FIG. 2, the speech-to-text-conversion-unit 210 converts the name (Name_1) and call sign (Call Sign_1) of other ship_1 (YS_1) and called counterpart's name and call sign into text information (Text_1) together with voice information (Speech_1) and stores them together. Next, this process is performed for other ship_2 (YS_2) to other ship_5 (YS_5) separately, and each is converted and stored.

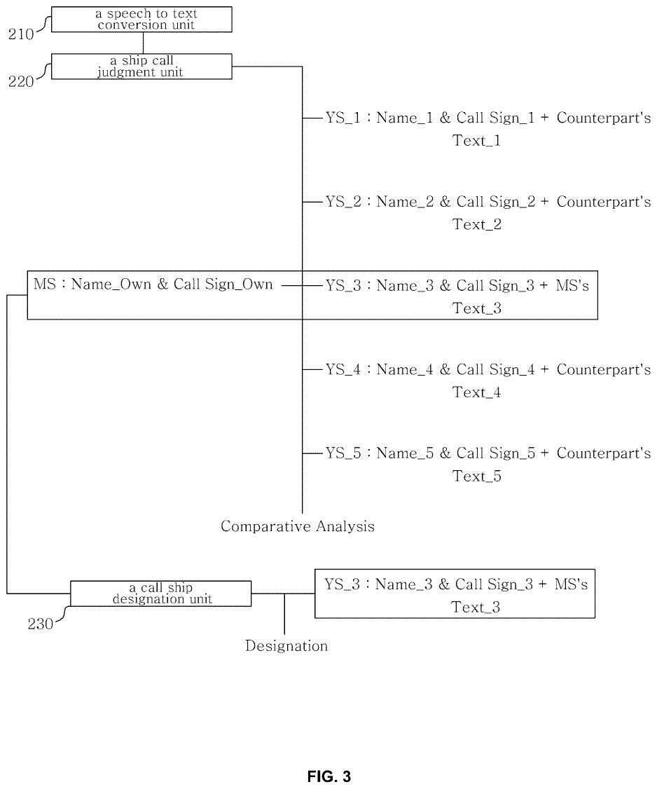

A ship-call-judgment-unit 220, as shown in FIG. 3, analyzes each of the text information (Text_1˜5) stored in the speech-to-text-conversion-unit 210 to determine whether there is text information (Text_3) that matches the name (Name_Own) or call sign (Call Sign_Own) of the own ship (MS). For example, as shown in FIG. 3, it can be seen that the text information (Text_1, 2, 4, 5) of each of other ships (YS_1, 2, 4, 5) do not match the name or call sign of the own ship (MS), but the text information (Text_3) of the other ship_3 (YS_3) matches the name or call sign of the own ship (MS).

At this time, a call-ship-designation-unit 230, as shown in FIG. 3, designates the other ship_3 (YS_3) that called the own ship (MS) from the text information (Text_1˜5) of each ship stored in the speech-to-text-conversion-unit 210 when the text information (Text_3) matching the name (Name_Own) or call sign (Call Sign_Own) of the own ship (MS) is received through the ship-call-judgment-unit 220.

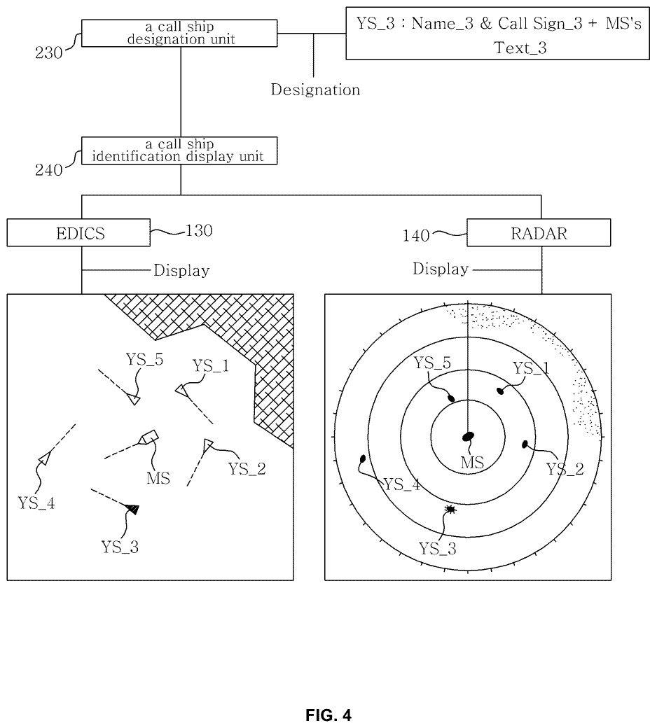

Next, the call-ship-identification-display-unit 240, as shown in FIG. 4, displays an image of the other ship_3 (YS_3) specified on the screen of EDICS 130 or RADAR 140 differently from other ships (YS_1, 2, 4, 5) when the call-ship-designation-unit 230 designates the other ship_3 (YS_3) that called the own ship (MS). For example, there may be various methods to increase the distinguishability, such as displaying the image of the commonly used ship in a triangle shape in a different color, or making it blink.

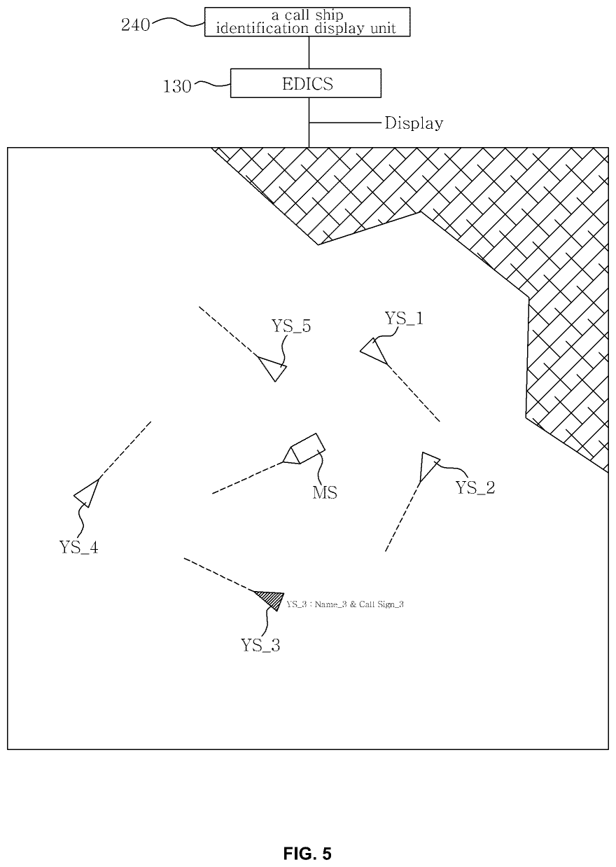

Accordingly, even in a situation where there are a large number of other ships (YS_1˜5) around the own ship (MS) as shown in FIGS. 4 and 5, when the other ship_3 (YS_3) calls the own (ship MS), the image of the other ship_3 (YS_3) is displayed differently from other ships (YS_1, 2, 4, 5) on the screen of EDICS 130 or RADAR 140, so that the own ship (MS) can intuitively identify it. By clicking or touching the image of the other ship_3 (YS_3) identified in this way, the name (Name_3) and call sign (Call Sign_3) of the other ship_3 (YS_3) can be immediately known, so that the own ship (MS) can quickly respond and react to the call of the other ship_3 (YS_3).

In addition, when the other ship_3 (YS_3) calls the own ship (MS), the name (Name_3) and call sign (Call Sign_3) of the other ship_3 (YS_3) can be immediately recognized without clicking or touching the image of the other ship_3 (YS_3) displayed on the screen of EDICS 130 or the RADAR 140. That is, the call-ship-identification-display-unit 240, as shown in FIG. 5, can display the name (Name_3) and call sign (Call Sign_3) of the other ship_3 (YS_3) as a text image next to the image of the designated the other ship_3 (YS_3) that called the own ship (MS).

Although the above-mentioned voice-to-text conversion technology, i.e. voice recognition technology, has a very high level of accuracy due to the development of AI technology, in order to confirm whether the voice information (Speech_3) of the other ship_3 (YS_3) that called the own ship (MS) and the converted text information (Text_3) actually match, the own ship (MS) needs to listen to the actual voice information (Speech_3) called by the other ship_3 (YS_3).

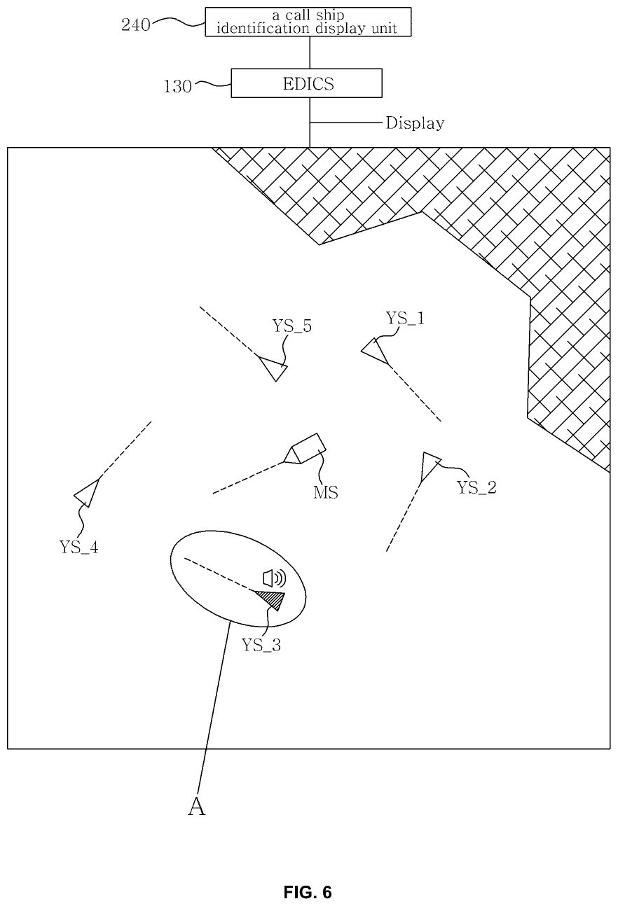

To this end, the call-ship-identification-display-unit 240, as shown in FIG. 6, may display a speaker-shaped icon on the image of the designated the other ship_3 (YS_3) that called the own ship (MS). This speaker-shaped icon display has a function of identifying the image of the other ship_3 (YS_3) by displaying it differently from other ships (YS_1, 2, 4, 5), and also has an input function for listening to voice information (Speech_3) of the other ship_3 (YS_3).

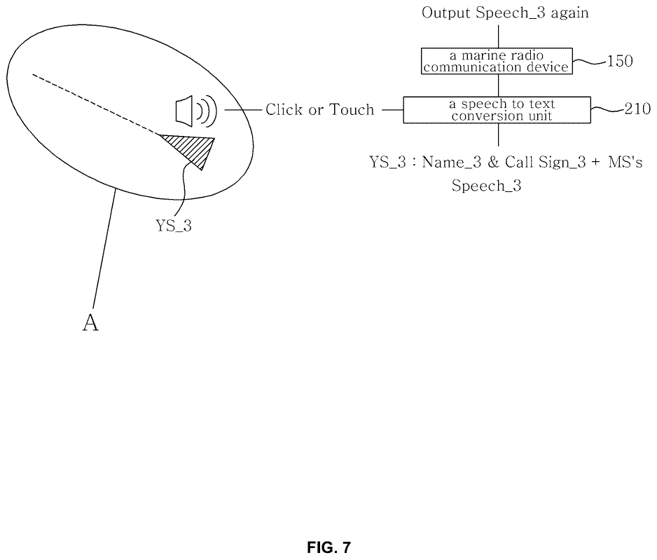

That is, when the speaker-shaped icon is clicked or touched as shown in FIGS. 6 and 7, the voice information (Speech_3) stored in the speech-to-text-conversion-unit 210 can be reproduce through the marine-radio-communication-device 150 of the own ship (MS). Accordingly, the own ship (MS) can quickly recognize the other ship_3 (YS_3) that has called the own ship (MS), and can also quickly check the name (Name_3) and call sign (Call Sign_3) of the other ship_3 (YS_3) in order to respond and react to the call of the other ship_3 (YS_3). In addition, it is possible to re-verify whether the actual voice information (Speech_3) of the other ship_3 (YS_3) and the converted text information (Text_3) match, so that there is an effect of preventing calling mistakes between each other.

Meanwhile, the present invention aims to help prevent maritime accidents in advance by helping to facilitate radio communication between the own ship (MS) and other ships (YS) even when they use different languages.

For example, the above-described voice-to-text conversion technology of the speech-to-text-conversion-unit 210, i.e., the voice recognition technology, is mainly targeted at the native language of the own ship (MS) and English, which is an international common language. However, since the ship inevitably encounters ships from other countries during its operation, it should be able to assist in radio communication with other ships (YS) that use languages other than the native language of the own ship (MS) or English. To this end, as shown in FIGS. 8 to 12, a text-translation-storage-unit 250 and a voice-synthesis-storage-unit 260 may be further comprised.

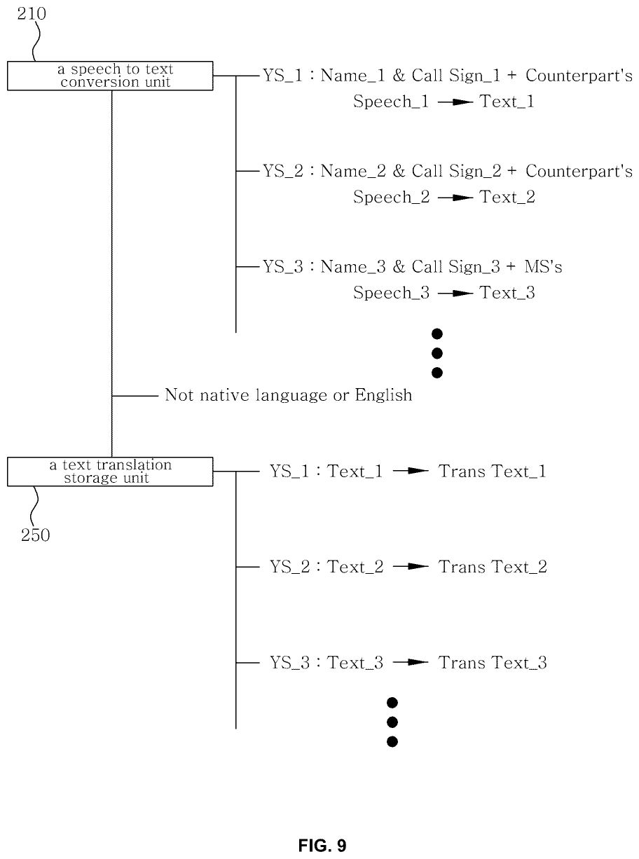

That is, a text-translation-storage-unit 250, as shown in FIGS. 8 and 9, translates the text information (Text_n) into the native language of the own ship (MS) and maritime English and saves it as text translation information (Trans Text_n) when the text information (Text_n) stored in the speech-to-text-conversion-unit 210 is not in the native language of the own ship (MS) or maritime English.

For example, as shown in FIG. 9, the speech-to-text-conversion-unit 210 converts the name (Name_1) and call sign (Call Sign_1) of other ship_1 (YS_1) and called counterpart's name and call sign into text information (Text_1) along with the voice information (Speech_1) and stores them together.

At this time, if the text information (Text_1) of other ship_1 (YS_1) is not the native language of the own ship (MS) or maritime English, the text-translation-storage-unit 250 translates the text information (Text_1) of other ship_1 (YS_1) into the native language of the own ship (MS) and maritime English and stores it as text translation information (Trans Text_1). Next, this process is performed for other ship_2 (YS_2) to other ship_5 (YS_5) separately, and each is translated and stored.

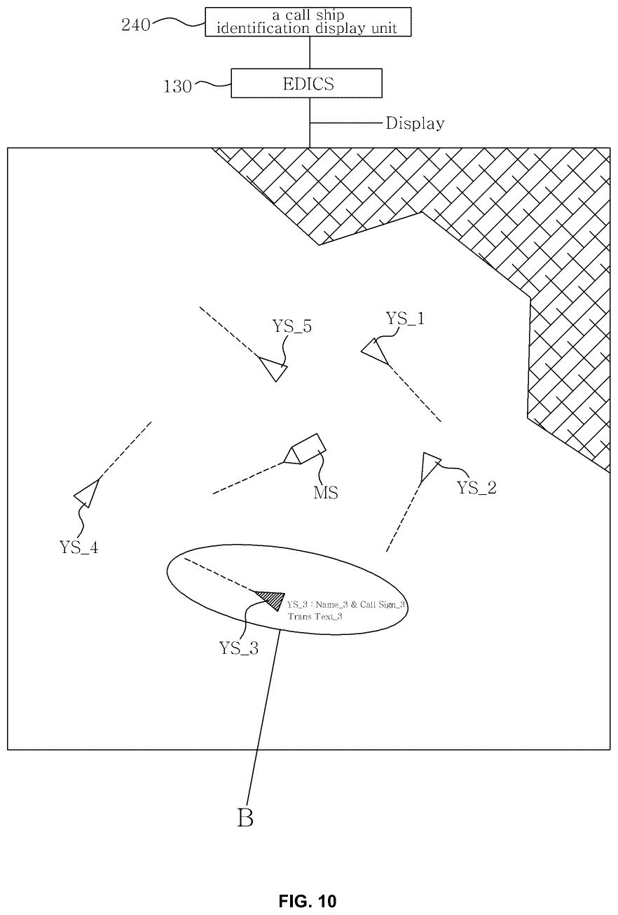

In this case, the call-ship-identification-display-unit 240, as shown in FIG. 10, can displays not only the text image of the name (Name_3) and call sign (Call Sign_3) of the other ship_3 (YS_3) next to the image of the other ship_3 (YS_3) that called the own ship (MS), but also a text image of the text translation information (Trans Text_3) stored in the text-translation-storage-unit 250.

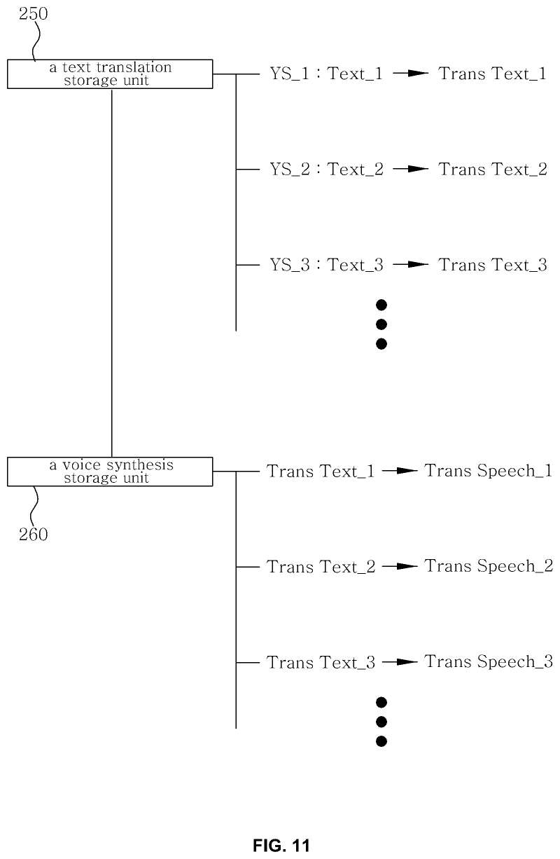

In addition, a voice-synthesis-storage-unit 260, as shown in FIGS. 8 and 11, converts the text translation information (Trans Text_n) stored in the text-translation-storage-unit 250 into voice translation information (Trans Speech_n) by synthesizing voice and saves it. That is, the voice-synthesis-storage-unit 260 is a TTS (Text to Speech) technology as a speech synthesis technology, and is a technology in which text information (Text) is input and a machine automatically creates speech information (Speech), which is a corresponding sound wave. Simply put, it is a technology in which the voice of a person selected as a model is recorded, divided into certain voice units, codes are attached, and then input into a synthesizer, and only the necessary voice units are combined again according to instructions to artificially create speech sounds. This previous UTS (Unit-selection Text-to-Speech) method has recently developed into SPM (Statistical Parameter Model) method, to the point where it is difficult to distinguish it from actual human speech sounds.

For example, the text-translation-storage-unit 250, as illustrated in FIG. 11, translates text information (Text_1) of other ship_1 (YS_1) into the native language of the own ship (MS) and maritime English and stores it as text translation information (Trans Text_1), and at this time, the voice-synthesis-storage-unit 260 synthesizes the text translation information (Trans Text_1) into speech and stores it as speech translation information (Trans Speech_1). Next, this process is performed for other ship_2 (YS_2) to other ship_5 (YS_5) separately, and each is synthesizes speech and stored.

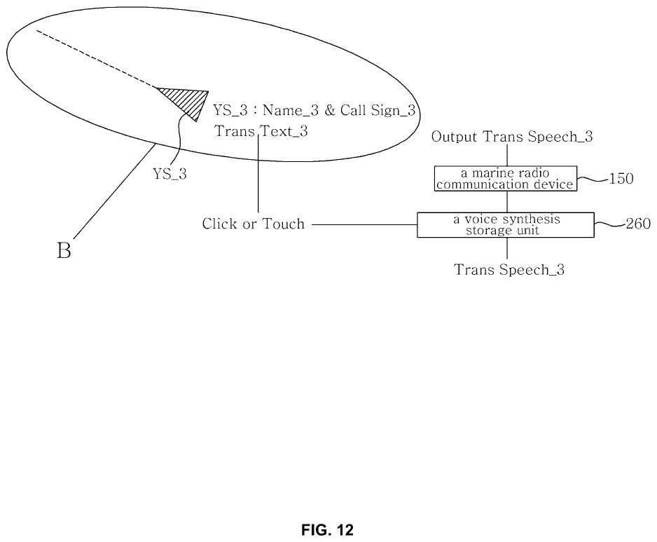

The above-mentioned call-ship-identification-display-unit 240, as shown in FIG. 10, displays a text image of the text translation information (Trans Text_3) stored in the text-translation-storage-unit 250 next to the image of the designated the other ship_3 (YS_3) that called the own ship (MS). At this time, the call-ship-identification-display-unit 240, as shown in FIG. 12, can output the voice translation information (Trans Speech_3) stored in the voice-synthesis-storage-unit 260 through the marine-radio-communication-device 150 of the own ship (MS) when the text image of the text translation information (Trans Text_3) is clicked or touched.

Accordingly, even when the own ship (MS) and the other ship_3 (YS_3) speak different languages, the own ship (MS) can quickly check the name (Name_3) and call sign (Call Sign_3) of the other ship_3 (YS_3) that called the own ship (MS), along with the text translation information (Trans Text_3) in the native language of the own ship (MS) and maritime English that the own ship (MS) can recognize, and if necessary, can even listen to the synthesized voice translation information (Trans Speech_3), which facilitates radio communication between the ships and can thus prevent maritime accidents in advance.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### DESCRIPTION OF REFERENCE SYMBOLS

MS: the own ship
YS, YS_n: other ships, other ship_n
YS_1, 2, 4, 5: other ship_1, 2, 4, 5
YS_3: the other ship_3 (that called the own ship)
110: AIS
120: GPS
130: EDICS
140: RADAR
150: a marine-radio-communication-device
210: a speech-to-text-conversion-unit
220: a ship-call-judgment-unit
230: a call-ship-designation-unit
240: a call-ship-identification-display-unit
250: a text-translation-storage-unit
260: a voice-synthesis-storage-unit

What is claimed is:

1. A safety navigation support system for a ship, comprising EDICS and RADAR that display navigation information on each screen in conjunction with GPS and AIS along with various sensors installed on the ship, and a marine-radio-communication-device that transmits and receives voice signals between the own ship and other ships, and further comprising:
a speech-to-text-conversion-unit that converts voice information received from other ships through the marine-radio-communication-device of the own ship into text information and stores the voice information and text information together for each ship;
a ship-call-judgment-unit that analyzes each of the text information stored in the speech-to-text-conversion-unit to determine whether there is text information that matches the name or call sign of the own ship;
a call-ship-designation-unit that designates the other ship that called the own ship from the text information of other ships stored in the speech-to-text-conversion-unit when the text information matching the name or call sign of the own ship is received through the ship-call-judgment-unit; and
a call-ship-identification-display-unit that displays an image of the other ship specified on the screen of EDICS or RADAR differently from other ships when the call-ship-designation-unit designates the other ship that called the own ship.

2. The safety navigation support system for a ship according to claim 1, wherein the call-ship-identification-display-unit displays the name and call sign of the other ship as a text image next on the screen to the image of the other ship that called the own ship.

3. The safety navigation support system for a ship according to claim 1, wherein the call-ship-identification-display-unit displays a speaker-shaped icon on top of the image of the other ship that called the own ship.

4. The safety navigation support system for a ship according to claim 3, wherein the call-ship-identification-display-unit reproduces the voice information stored in the speech-to-text-conversion-unit through the marine-radio-communication-device of the own ship when the speaker-shaped icon is clicked or touched.

5. The safety navigation support system for a ship according to claim 1, characterized by further comprising:
a text-translation-storage-unit that translates the text information into the native language of the own ship and maritime English and saves it as text translation information when the text information stored in the speech-to-text-conversion-unit is not in the native language of the own ship or maritime English.

6. The safety navigation support system for a ship according to claim 5, wherein the call-ship-identification-display-unit displays not only the text image of the name and call sign of the other ship next to the image of the other ship that called the own ship, but also a text image of the text translation information stored in the text-translation-storage-unit.

7. The safety navigation support system for a ship according to claim 6, characterized by further comprising:
a voice-synthesis-storage-unit that converts the text translation information stored in the text-translation-storage-unit into voice translation information by synthesizing voice and saves it.

8. The safety navigation support system for a ship according to claim 7, wherein the call-ship-identification-display-unit outputs the voice translation information stored in the voice-synthesis-storage-unit through the marine-radio-communication-device of the own ship when the text image of the text translation information is clicked or touched.
